(19) United States
(12) Patent Application Publication
(10) Pub. No.: US 2010/0067232 A1
(43) Pub. Date: Mar. 18, 2010

(54) ELECTRONIC DEVICE

(75) Inventor: SHR-CHING LUO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/399,221

(22) Filed: Mar. 6, 2009

(30) Foreign Application Priority Data
Sep. 17, 2008 (CN) 200810304538.6

(51) Int. Cl. F21V 14/00

(52) U.S. Cl. 362/259; 353/42

(57) ABSTRACT

The invention discloses an electronic device. The electronic device includes a housing, a laser device, and an optical unit. The housing defines an opening. The laser device is positioned in the housing. The laser device comprises a light output area corresponds to the opening of the housing. The optical unit includes an optical plate and is movably movable into and out of the light path of the laser device to scatter or not scatter the emitted light, respectively.

### BACKGROUND

1. Field of the Invention

The present invention generally relates to electronic devices, and particularly to an electronic device with a lighting function and a laser pointer function.

2. Discussion of the Related Art

With the development of wireless communication and information processing technologies, portable electronic devices such as mobile phones and personal digital assistants (PDAs) are now in widespread use, and consumers may now enjoy the full convenience of high technology products almost anytime and anywhere. Portable electronic devices, such as mobile phones, often have a lighting function used for illumination (e.g. in dark environments) and a laser pointer function used to highlight items of interest during a presentation.

A typical mobile phone having a lighting function and a laser pointer function includes a lighting device, a laser device, and a switch. The light source, the laser device and the switch are connected in series. When the switch is turned to a first position, the lighting device works. When the switch is turned to a second position, the laser device works. However, the mobile phone has both a lighting device and a laser device. Therefore, the mobile phone has a high cost.

Therefore, there is room for improvement within the art.

### BRIEF DESCRIPTION OF THE DRAWING

Many aspects of the present electronic device can be better understood with reference to the following drawings. The components in the drawings are not necessarily drawn to scale, the emphasis instead being placed upon clearly illustrating the principles of the present electronic device. Moreover, in the drawings, like reference numerals designate corresponding parts throughout the several views.

FIG. 1 shows a schematic, exploded, perspective view of an electronic device.

FIG. 2 shows an assembled, perspective view of the electronic device in FIG. 1.

FIG. 3 is similar to FIG. 2, but removing a first cover of the electronic device, showing the electronic device used as a laser pointer.

FIG. 4 is similar to FIG. 3, but showing the electronic device used as a lamp.

### DETAILED DESCRIPTION OF THE EMBODIMENT

The present electronic device may be, such as mobile phones, PDAs, and etc. For the purposes of conveniently describing one embodiment of an electronic device, a mobile phone is used to describe the foldable electronic device of the present embodiment.

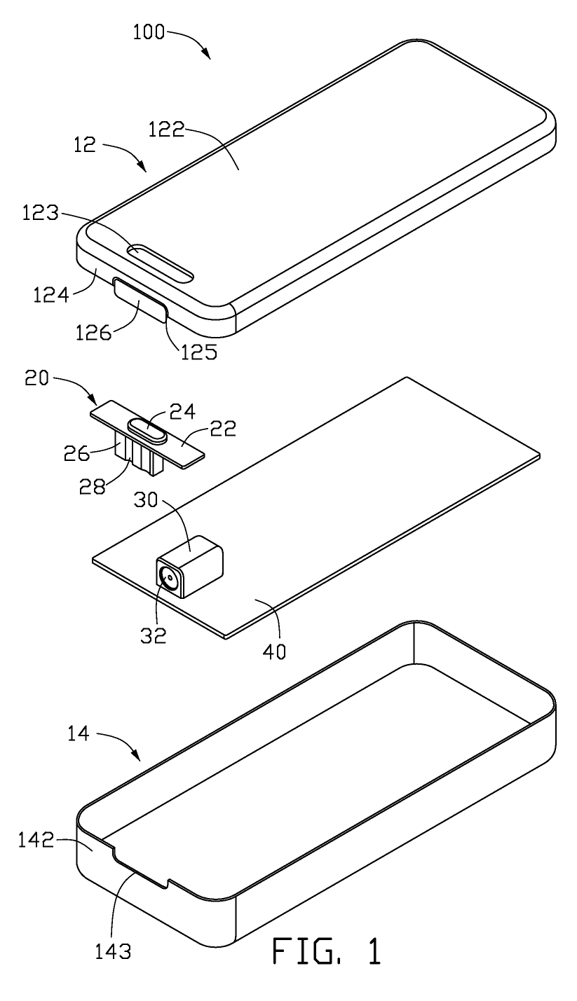

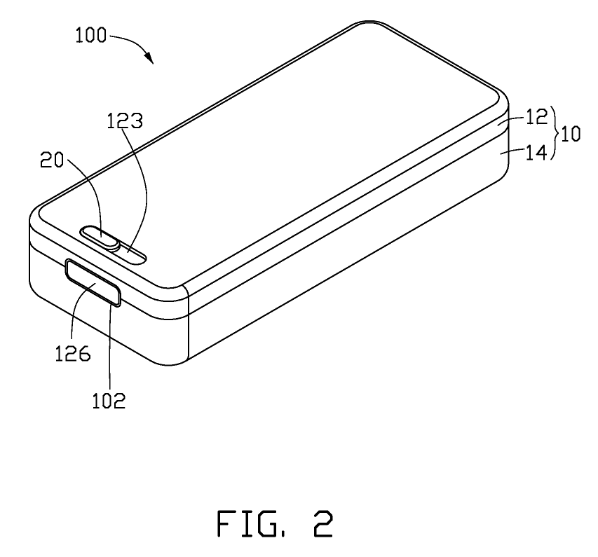

Referring to FIG. 1, a schematic, perspective view of an electronic device 100 is provided. The electronic device 100 includes a housing 10 (see FIG. 2), an optical unit 20, a laser device 30, and a printed circuit board 40. The optical unit 20 is movably mounted to the housing 10. The laser device 30 is electrically connected to the printed circuit board 40.

The housing 10 includes a first cover 12 and a second cover 14 coupled to the first cover 12. The first cover 12 has a first surface 122 and a second surface 124 adjoining to the first surface 122. A display screen (not shown) and a keyboard (not shown) are positioned in the housing 10 and exposed through the first surface 122. The first cover 12 defines a guiding slot 123 in the first surface 122 and a first cutout 125 in the second surface 124. The guiding slot 123 and the first cutout 125 are adjacent to and communicate with each other. The second cover 14 has a third surface 142 configured for aligning and adjoining to the second surface 124 of the first cover 12. The second cover 14 defines a second cutout 143 in the third surface 142. When the first cover 12 couples to the second cover 14, the first cutout 125 and the second cutout 143 cooperatively form an opening 102. The housing 10 further includes a light transmitting sheet 126 disposed in the opening 102, thus preventing dust and particles from entering the housing 10. The light transmitting sheet 126 may be made of materials allowing light transmitting therethrough such as glass or resin.

The optical unit 20 includes a base 22, a button 24, and an optical plate 26. The button 24 and the optical plate 26 are formed on opposite sides of the base 22. The button 24 is slidably received in the guiding slot 123 of the housing 10 and partially protrudes out of the housing 10. The optical plate 26 is configured for scattering light. In the illustrated embodiment, the optical plate 26 has a curved surface defining a plurality of grooves. The optical plate 26 may be made of materials allowing light transmitting therethrough such as glass or resin. The optical unit 20 is slidable relative to the housing 10 along a direction parallel to the second surface 124. The base 22 and the optical plate 26 of the optical unit 20 are positioned inside the housing 10 and between the first cover 12 and the second cover 14.

The laser device 30 includes a light output area 32. The laser device 30 is positioned in the housing 10, and the light output area 32 faces the opening 102, thus allowing light from the laser device 30 emitting out from the housing 10 via the opening 102. The laser device 30 may be free electron laser devices, carbon dioxide lasers, or diode lasers. In the illustrated embodiment, the laser device 30 is a diode laser.

The printed circuit board 40 includes circuit modules such as a driving circuit and a controlling circuit of the laser device 30 and a communication module of the electronic device 100. The laser device 30 is electrically connected to the printed circuit board 40. The laser device 30 can be turned on or turned off by controlling one of the circuit modules on the printed circuit board 40.

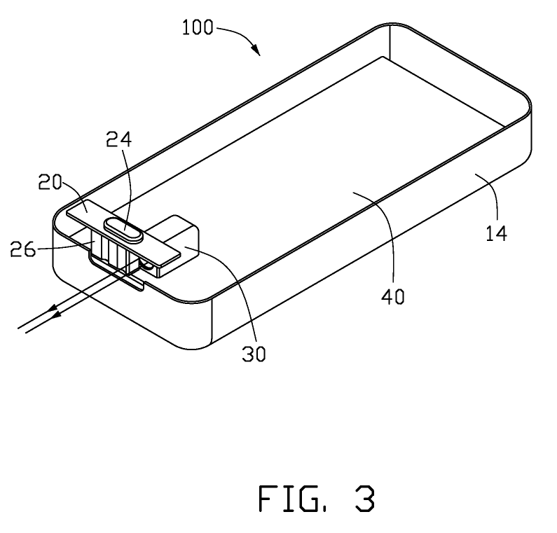

Referring to FIGS. 1 and 3, when the electronic device 100 is used as a laser pointer, the button 24 of the optical unit 20 slides to an end of the guiding slot 123 of the housing 10, thereby moving the optical plate 26 out of the path of light emitted through the light output area 32, and the laser device 30 is turned on by controlling the circuit module on the printed circuit board 40. Light from the laser device 30 passes through the light transmitting sheet 126 of the housing 10 and emits out of the housing 10 without passing through the optical plate 26.

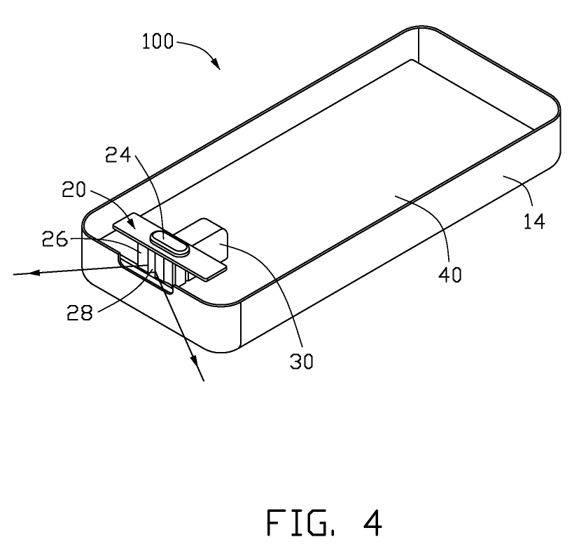

Referring to FIGS. 1 and 4, when the electronic device 100 is used as a lamp, the button 24 of the optical unit 20 slides to an opposite end of the guiding slot 123 of the housing 10, thereby moving the optical plate 26 into the path of light emitted through the light output area 32, and the laser device 30 is turned on by controlling the circuit module on the printed circuit board 40. Accordingly, light from the laser device 30 is scattered by the optical plate 26 and then passes through the light transmitting sheet 126 to emit out of the housing 10. Such scattered light is suitable to be used as a lamp to perform a lighting function.

The electronic device 100 does not employ any lighting device, yet can perform as a lamp. Therefore, the electronic device 100 has a low cost and is relatively simple.

It is understood that the opening 102 of the housing 10 may be defined in other positions of the housing 10, such as the first surface 122 of the first cover 12.

It is understood that the optical unit 20 may be positioned out of the housing 10. The optical unit 20 may be rotatably connected to the housing 10, so long that the optical plate 26 is movable to offset from or cover the light output area 32 of the laser device 30.

It is to be understood, however, that even though numerous characteristics and advantages of the present invention have been set forth in the foregoing description, with details of the structure and function of the present invention, the disclosure is illustrative only, and changes may be made in detail, especially in matters of shape, size, and arrangement of parts within the principles of present invention to the full extent indicated by the broad general meaning of the terms in which the appended claims are expressed.

What is claimed is:

1. An electronic device comprising:
a housing defining an opening;
a laser device positioned in the housing, the laser device comprising a light output area in the path of emitted light and corresponding to the opening of the housing; and
an optical unit movably connected to the housing and configured for scattering light, the optical unit being movable into and out of the light path of the laser device.

2. The electronic device as claimed in claim 1, wherein the optical unit comprises a base, a button, and an optical plate, the button and the optical plate are formed on opposite sides of the base; the optical plate is configured for scattering light.

3. The electronic device as claimed in claim 2, wherein the optical plate has a curved surface defining a plurality of grooves and the curved surface is configured for scattering light.

4. The electronic device as claimed in claim 3, wherein the optical plate is made of glass or resin.

5. The electronic device as claimed in claim 2, wherein the housing defines a guiding slot, the button of the laser device is slidably received in the guiding slot and protrudes out of the housing through the guiding slot.

6. The electronic device as claimed in claim 5, wherein the base and the optical plate of the optical unit are positioned inside the housing.

7. The electronic device as claimed in claim 5, wherein the housing comprises a first cover and a second cover coupled to the first cover; the first cover has a first surface and a second surface adjoining to the first surface, the first cover defines the guiding slot in the first surface and a first cutout in the second surface, the guiding slot and the cutout communicate with each other; the second cover has a third surface configured for aligning to the second surface of the first cover, the second cover defines a second cutout in the third surface, the first cutout and the second cutout cooperatively form the opening.

8. The electronic device as claimed in claim 5, wherein the housing further comprises a light transmitting sheet disposed in the opening.

9. The electronic device as claimed in claim 8, wherein the light transmitting sheet is made of glass or resin.

10. The electronic device as claimed in claim 1, wherein the laser device is a free electron laser device, a carbon dioxide laser, or a diode laser.

11. The electronic device as claimed in claim 1, further comprising a printed circuit board, the laser device is electrically connected to the printed circuit board.

12. An electronic device comprising:
a housing;
a laser device positioned in the housing, the laser device configured for emitting light out of the housing; and
an optical unit movably connected to the housing and configured for scattering light, the movement of the optical unit causing light from the laser device to be scattered or not scattered by the optical unit.

13. The electronic device as claimed in claim 12, wherein the housing defines an opening, the laser device comprises a light output area corresponding to the opening of the housing.

14. The electronic device as claimed in claim 13, wherein the optical unit comprises a base, a button, and an optical plate, the button and the optical plate are formed on opposite sides of the base; the optical plate is configured for scattering light.

15. The electronic device as claimed in claim 14, wherein the optical plate has a curved surface defining a plurality of grooves and the curved surface is configured for scattering light.

16. The electronic device as claimed in claim 14, wherein the housing defines a guiding slot, the button of the laser device is slidably received in the guiding slot and protrudes out of the housing through the guiding slot.

17. The electronic device as claimed in claim 16, wherein the housing comprises a first cover and a second cover coupled to the first cover; the first cover has a first surface and a second surface adjoining to the first surface, the first cover defines the guiding slot in the first surface and a first cutout in the second surface, the guiding slot and the cutout communicate with each other; the second cover has a third surface configured for aligning to the second surface of the first cover, the second cover defines a second cutout in the third surface, the first cutout and the second cutout cooperatively form the opening.

18. The electronic device as claimed in claim 16, wherein the housing further comprises a light transmitting sheet disposed in the opening.
